(19) United States
(12) Patent Application Publication
(10) Pub. No.: US 2017/0181007 A1
(43) Pub. Date: Jun. 22, 2017

(54) METHOD FOR A PLACEMENT OF INTERNET GATEWAY (IGW) IN A BACKBONE WIRELESS MESH NETWORKS (BWMNS)

(71) Applicant: Universiti Putra Malaysia, Serdang Selangor (MY)

(72) Inventors: Mohamed Othman, Serdang Selangor (MY); Najib Ahmed Mohammed, Serdang Selangor (MY)

(21) Appl. No.: 15/266,079

(22) Filed: Sep. 15, 2016

(30) Foreign Application Priority Data
Dec. 18, 2015 (MY) PI 2015704638

(51) Int. Cl. H04W 16/20; H04W 28/08

(52) U.S. Cl. CPC H04W 16/20; H04W 28/085; H04W 84/18

(57) ABSTRACT

The present innovation relates to a method for a placement of Internet Gateway (IGW) in a Backbone Wireless Mesh Networks (BWMNs) comprising: selecting the proper IGW (100); calculating the largest path the one degree nodes can reach with delay constraint (200); assigning Web Mesh Routers (WMRs) nodes to the identified IGW (300); forming a cluster with the largest degree node is the identified IGW (400); recalculating the position of IGW for intra-load balancing (500); assigning the node that has the maximum load radio to be the new IGW of the cluster (600); updating the rest of BWMN nodes (700); and forming the next clusters until no more WMR left (800). The present invention provides IGWs placement in the design phase while satisfying load balancing among IGWs and WMRs and under QoS constraints. The balancing acts encompass balancing over the load among IGWs of the entire BWMN and balancing over the load among WMRs of the entire BWMN.

### CROSS-REFERENCE TO RELATED APPLICATIONS

This application claims priority to Malaysian patent application no. PI 2015704638, filed Dec. 18, 2015, the content of which is hereby incorporated by reference in its entirety.

### FIELD OF INVENTION

The present invention relates to a protocol or method for a placement of Internet Gateway (IGW) in a wireless network.

### BACKGROUND OF INVENTION

Backbone Wireless Mesh Networks (BWMNs) are becoming a popular solution to extend access networks and draw lots of attentions in recent years due to their ability to connect to various existing wireless networks and its support of diversity of applications. BWMNs connects Wi-Fi, WiMAX, cellular, wireless sensor, and WiMedia networks. Besides, they support various potential applications, such as community and neighbourhood networks, enterprise networking, and broadband home networking with low cost compared to wired networks. All these advantages reinforce BWMNs as a promising wireless technology for numerous applications.

A BWMN consists of a collection of Wireless Mesh Routers (WMRs), each of which can communicate with other WMRs and Mobile Clients (MCs). Each WMR forwards packages on behalf of other WMRs and MCs. Intermediate WMRs do lots of functions, such as boosting the signals, pass data from point to point, and perform routing by making forwarding decisions based on their knowledge of the network. WMRs routers are generally not mobile. However MCs connect to the wireless network through a WMR and they do not have restriction on mobility. BWMN consists of some special WMRs, called Internet Gateways (IGWs) which act as communication bridges with multiple interfaces to connect to both wired and wireless networks. The IGW is the essential component of BWMNs design. It is responsible for connecting the WMN to the wired backbone thus its placement plays a crucial role in BWMN architecture towards high-bandwidth network coverage and provide Internet accessibility. Therefore, IGWs are expensive and there are only a few of them in the network. However, the path of traffic, being aggregated from a large number of end users, changes infrequently. Practically, all the traffic in a WMN infrastructure is either forwarded to or from an IGW. Due to the nature of BWMN as a multi-hop network, there is a significant delay occurs at each hop as a contention in the wireless channel, packet processing, and packet queuing. The delay is calculated as a function of the number of communication hops between WMR and its IGW, also the delay occurs due to the links (Relay) of each node in the path from IGW to WMRs.

Load balancing in BWMN is a method to distribute workload across multiple WMRs or IGWs to achieve optimal resource utilization and throughput maximization. The load in the design phase of BWMN can be classified into two types: first, Intra-Load which is related to the load of each WMR as the commutative WMR hops attached to its IGW in each cluster; second, is called Inter-Load which is related to the load of each IGW as the number of WMRs attached to the IGW.

The Intra-Load balance is related to fairly distributing the delay hops from IGWs to all WMRs assigned to them. However the Inter-Load balance is related to distributing the total number of WMRs fairly between their identified IGWs in BWMN to ensure fairness among all IGWs.

Strategic choosing of IGWs in BWMN while ensuring load balancing among its components can qualify a number of performance-related problems, it also leads to better high-bandwidth network coverage, so their placement still an ongoing research problem, modeling it with graph theory, formulating it as an non-deterministic polynomial-time hard (NP-hard) multi-objective problem and solving it using clustering-based approach.

Majority of IGW selection methods focus on improving IGW placement optimization for BWMNs without considering load balancing and QoS constraints. Most of load balancing schemes are focusing on balancing the load during run-time of the network or balancing the load during IGW deployment without considering IGW optimization. Some load balancing algorithms focus on balancing the load among IGWs or WMRs. The existing methods of IGW placement are merely efficient for small WMNs clusters with only one IGW. The current existing studies and methods were aiming at optimizing of IGWs placement considering only one QoS constraint which is Delay.

One example of prior arts which addresses the problem is U.S. Pat. No. 8,780,730 which reads a gateway system determines whether load conditions are heavy or light according to a predetermined criterion. If load conditions are light, the gateway operates in reactive mode. If load conditions are heavy, the gateway operates in proactive mode.

The above cited prior art however appears to has some drawbacks still, as it divides the load only for the IGWs whose have already been selected, and the load balancing process of IGW occurs during the run-time based on the load of the MCs. It is also found that WMR can be assigned to more than one IGW.

Therefore, there is an alarming need for an invention that able to address those drawbacks.

### SUMMARY OF INVENTION

According to an aspect of the present invention, the present invention provides a method for a placement of Internet Gateway (IGW) in a Backbone Wireless Mesh Networks (BWMNs) comprising: selecting the proper IGW by looking for one degree nodes (100); calculating the largest path the one degree nodes can reach with delay constraint (200); assigning Wireless Mesh Routers (WMRs) nodes to the identified IGW (300); forming a cluster with the largest degree node is the identified IGW (400); recalculating the position of IGW for intra-load balancing by looking for the total load radio for each WMR in the cluster including the identified IGW (500); assigning the node that has the maximum load radio to be the new IGW of the cluster (600); updating the rest of BWMN nodes by removing the identified IGW and its member set and their links from other nodes outside the boundary of the cluster from adjacency matrix (700); and forming the next clusters until no more WMR left (800).

The above provision is advantageous as the present invention provides IGWs placement in the design phase while satisfying load balancing among IGWs and WMRs and under QoS constraints. The balancing acts encompass balancing over the load among IGWs of the entire BWMN and balancing over the load among WMRs of the entire BWMN.

The present invention also provides control over IGWs locations to ensure them to be close to Internet resources, and the present invention works on any setup of BWMN topology and any network that has IGW.

Summarily, the present invention provides a novel protocol which: ensures IGWs optimization while IGW deployment, balances the load among BWMN components during design phase, balances the load among IGWs, balances the load among WMRs, satisfies QoS constraints, works for any BWMN topology setup (i.e. works for the BWMNs that form connected components or otherwise), and while the protocol introduces clustering technique and ensure avoidance of creating one-node clusters, and distributes the IGWs close to available Internet resources.

### BRIEF DESCRIPTION OF THE DRAWINGS

The present invention will be fully understood from the detailed description given herein below and the accompanying drawings as follows:

FIG. 1 illustrates a flowchart of the method of the present invention.

FIG. 2 illustrates algorithms which are involved in the method of the present invention.

FIG. 3 illustrates exemplary model of implementation of the method of the present invention.

### DETAILED DESCRIPTION OF THE PRESENT INVENTION

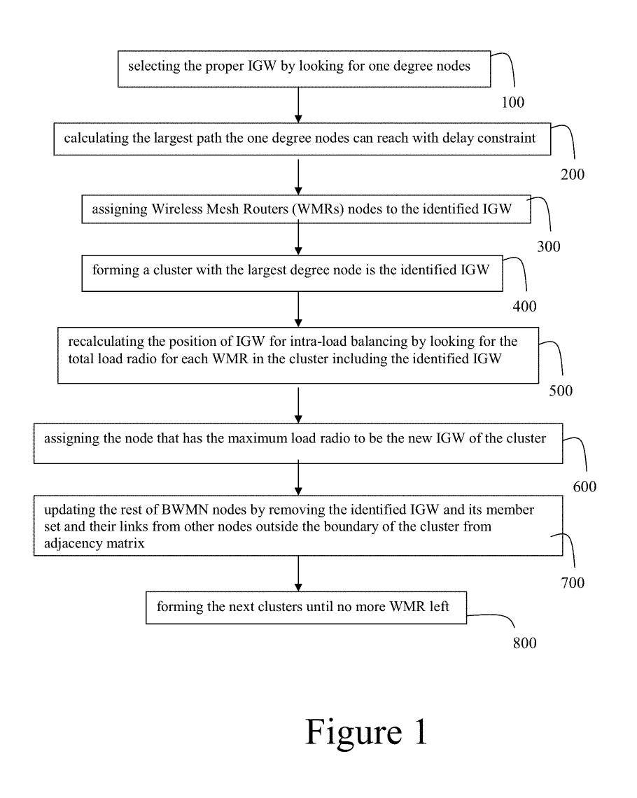

Generally, the present invention relates to a method for a placement of Internet Gateway (IGW) in a Backbone Wireless Mesh Networks (BWMNs) comprising: selecting the proper IGW by looking for one degree nodes (100); calculating the largest path the one degree nodes can reach with delay constraint (200); assigning WMRs to the identified IGW (300); forming a cluster with the largest degree node is the identified IGW (400); recalculating the position of IGW for intra-load balancing by looking for the total load radio for each WMR in the cluster including the identified IGW (500); assigning the node that has the maximum load radio to be the new IGW of the cluster (600); updating the rest of BWMN nodes by removing the identified IGW and its member set and their links from other nodes outside the boundary of the cluster from adjacency matrix (700); and forming the next clusters until no more WMR left (800). This provision is illustrated in FIG. 1. In the case if there is no one degree nodes registered in the network, or the network registers a plurality of nodes having the same delay hops, then the step (100) further comprising selecting the largest degree node to be the IGW (100A), (100B).

BWMN design starts by collecting some information such as number of nodes, connection radius and minimum distance, location size, and Quality of Service (QoS) parameters to generate the network graph as an adjacency matrix. All of these information act as inputs to proposed heuristic IGW placement algorithm of the present invention and the outputs are of the form number of IGWs and their clusters, intra-load balance ratio, Inter-load balance ratio, total load-balance ratio, largest IGW-WMR hop, and IGW-IGW hop.

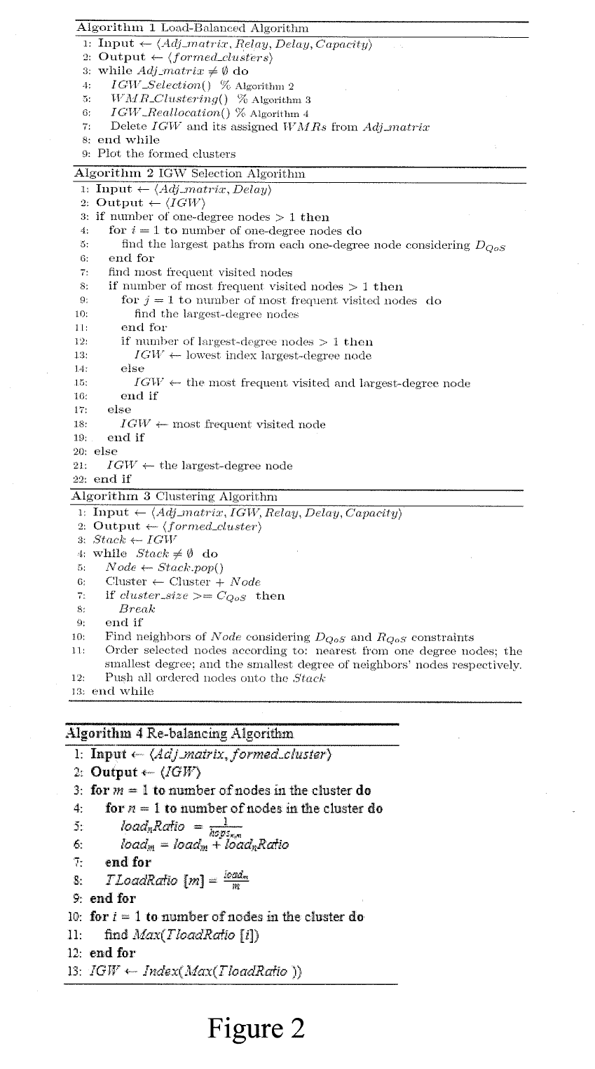

As in FIG. 2, load-balanced algorithm solves the IGW placement problem by iteratively 5 and incrementally identifying IGWs and assigns WMRs to identified IGWs considering QoS constraints based on the degree of nodes and their locations in the network model, then reallocating the IGWs within their clusters depending on the delay hops and relay links (i.e. balancing the intra-load), finally balancing the inter-load of WMRs assigned to each identified IGW. Algorithm 1 shows an iterative behavior, such that in each iteration, it identifies an IGW 10 from the current unassigned WMRs using IGW_selection algorithm, which is provided in Algorithm 2. Then forming IGW cluster by assigning WMRs to the identified IGW using clustering algorithm, which is provided in Algorithm 3. After that, the Re-balancing algorithm in which is provided in Algorithm 4 reallocates the IGW for load balancing task. Finally, the system updates the adjacency matrix by removing the identified IGW and its WMRs. It continues to do so until the adjacency matrix is empty.

### IGW Selection Algorithm

The algorithm shown in Algorithm 2 looks for the node which one degree nodes visit 20 more, considering the delay and relay constraints to select it as an IGW, otherwise the largest degree node will be selected as IGW. This mechanism of selecting IGWs ensure avoiding zero degree nodes at early stages and achieving objective of placing IGW closest to each other.

### WMRs Clustering Algorithm

Algorithm 3 assigns WMRs according to some ordered priorities; first priority is given to the location of nodes if they are closest to one degree nodes; the second priority is given for the largest degree nodes; and the last priority is given for smallest degree of nodes' neighbors, considering QoS constraints.

### Re-Balancing Algorithm

The purpose of this step is to ensure achieving the objective of maximizing the load balancing among IGWs and WMRs by evenly distributing WMRs to their IGWs and evenly distributing WMRs within their clusters. Algorithm 4 re-balances the load of a cluster by reallocating IGW based on the number of WMRs, their delay hops, and relay links. Calculating the load ratio for each WMR in the cluster and the largest WMR load ratio will be the new IGW of the cluster. The cluster C is fully load-balanced if and only if ∀vᵢ∈C has the same upper limit hops to the IGW of that cluster.

The present invention is best described in exemplary networking model as follows.

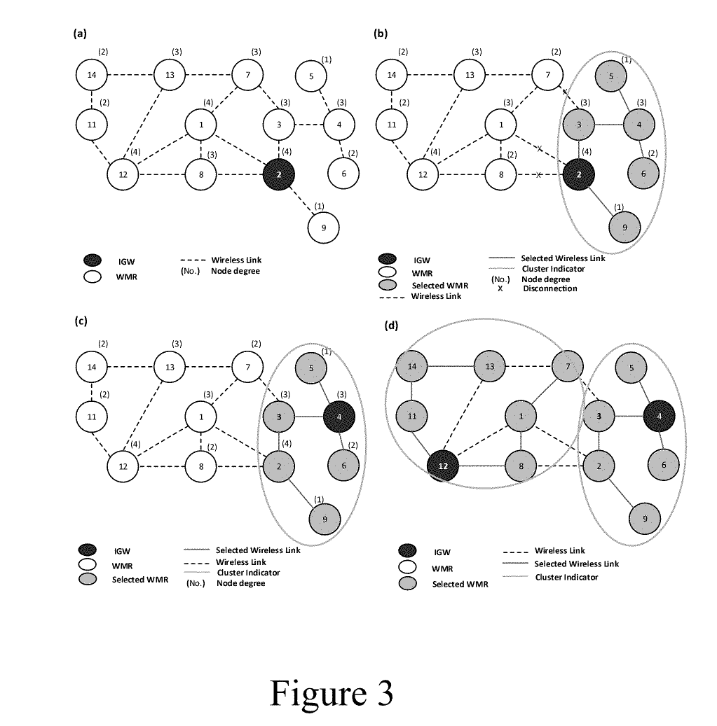

We consider a sample network topology with 13 nodes and we set the values of delay, relay, and capacity to be D_{QoS}≦3, R_{QoS}≦2, and C_{QoS}≦7 respectively. The first step of our proposed algorithm of the present invention is to select the proper IGW by looking for one degree nodes if they are exist (100). Then, calculating the largest path the one degree nodes can reach with delay constraint (200). As shown in FIGS. 3(a), 5,6, and 9 are one degree nodes (i.e. each one has one connection) so the longest path with delay length 3 the node 5 can pass through is [5,4,6]; [5,4,3,7]; and [5,4,3,2]. Also longest path with delay length 3 the node 6 can pass through is [6,4,5]; [6,4,3,7]; and [6,4,3,2]. Similarly the path of node 9 can pass through is [9,2,8,12]; [9,2,8,1]; [9,2,1,8]; [9,2,1,7]; [9,2,1,12]; [9,2,3,7]; and [9,2,3,4]. Therefore, the most visited nodes are 2, 3, 4, and 7, so the node 2 is selected as an IGW as the largest degree node than nodes 3, 4, and 7. The next step is to assign WMRs to the identified IGW (300). The node 9 is assigned first as the smallest degree node. For the same reason the node 3 is assigned to the IGW as the second WMR. The third node to assign is 4 although 7 has the same degree but the node 4 is the nearest to one degree nodes 5 and 6. Therefore, nodes 5 and 6 are selected following the same rules. Finally, no more nodes can be assigned to the IGW due to the constraint of relay, which is R_{QoS}≦2. Therefore, the first cluster is formed with the node 2 as an IGW and a member set of {3,4,5,6,9} (400).

FIG. 3(b) shows the cluster boundary, disconnected links, and the member nodes of the cluster. The next step is recalculating the position of IGW for intra-load balancing by looking for the total load radio for each WMR in the cluster including its IGW (500). However the load-radio of nodes 2, 3, 4, 5, 6, 9 is 0.527, 0.583, 0.639, 0.430, 0.430, 0.389, respectively. Noticing clearly that the node 4 has the maximum load radio, thus the node 4 will be selected as the new IGW of the cluster as shown in FIG. 3(c) (600). However, this step guarantees balancing the load among WMRs in the cluster. The next step is to update the rest of BWMN nodes by removing the identified IGW and their member set [2,3,4,5,6,9] and their links from other nodes outside the boundary of the cluster from adjacency matrix (700). Similarly the next clusters will be formed until no more WMR left (800). FIG. 3(d) shows the final BWMN model with its clusters set.

Although the innovation has been described with reference to particular embodiment, it is to be understood that the embodiment is merely illustrative of the principles and applications of the present innovation. It is therefore to be understood that numerous modifications may be made to the illustrative embodiment that other arrangements may be devised without departing from the scope of the present innovation as defined by the appended claims.

1. A method for a placement of Internet Gateway (IGW) in a Backbone Wireless Mesh Networks (BWMNs) comprising:
selecting the proper IGW by looking for one degree nodes (100);
calculating the largest path the one degree nodes can reach with delay constraint (200);
assigning Wireless Mesh Routers (WMRs) nodes to the identified IGW (300);
forming a cluster with the largest degree node is the identified IGW (400);
recalculating the position of IGW for intra-load balancing by looking for the total load radio for each WMR in the cluster including the identified IGW (500);
assigning the node that has the maximum load radio to be the new IGW of the cluster (600);
updating the rest of BWMN nodes by removing the identified IGW and its member set and their links from other nodes outside the boundary of the cluster from adjacency matrix (700); and
forming the next clusters until no more WMR left (800).

2. The method for a placement of Internet Gateway (IGW) in a Backbone Wireless Mesh Networks (BWMNs) as claimed in claim 1, wherein the step of selecting the proper IGW by looking for one degree nodes (100) further comprising selecting the largest degree node to be the IGW (100A) if the network registers no one degree nodes.

3. The method for a placement of Internet Gateway (IGW) in a Backbone Wireless Mesh Networks (BWMNs) as claimed in claim 1, wherein the step of selecting the proper IGW by looking for one degree nodes (100) further comprising selecting the largest degree node to be the IGW (100B) if the network registers a plurality of nodes having the same delay hops.
